(19) United States
(12) Patent Application Publication
(10) Pub. No.: US 2023/0196273 A1
(43) Pub. Date: Jun. 22, 2023

(54) METHODS AND SYSTEMS FOR MANAGING SHIPMENT OF PRODUCTS FROM A DISTRIBUTION CENTER

(71) Applicant: Walmart Apollo, LLC, Bentonville, AR (US)

(72) Inventors: Ehsan Nazarian, Rogers, AR (US); Behzad Nemati, Springdale, AR (US)

(21) Appl. No.: 18/170,705

(22) Filed: Feb. 17, 2023

Related U.S. Application Data
(63) Continuation of application No. 15/964,961, filed on Apr. 27, 2018.
(60) Provisional application No. 62/490,741, filed on Apr. 27, 2017.

(51) Int. Cl. G06Q 10/0835; G06Q 10/083

(52) U.S. Cl. CPC G06Q 10/08355; G06Q 10/0838

(57) ABSTRACT

Systems and methods are provided for managing shipment of a plurality of online orders for one or more carriers from a distribution center. The systems and methods include receiving online orders that each comprise a product and a delivery destination for delivering the product, determining the delivery destination for delivering the product of each of the online orders, determining a distribution center to fulfill the online orders, determine a route for each carrier to deliver products of the online orders. The route for each of the carriers can be determined based on a score, and can be in a generally curve shape starting from the distribution center, through the delivery destinations, and ending at the distribution center.

### CROSS REFERENCE TO RELATED APPLICATIONS

The present application is a continuation of U.S. patent application Ser. No. 15/964,961, filed Apr. 27, 2018, and entitled “METHODS AND SYSTEMS FOR MANAGING SHIPMENT OF PRODUCTS FROM A DISTRIBUTION CENTER,” which claims priority to U.S. Provisional Patent Application No. 62/490,741, filed on Apr. 27, 2017, entitled “METHODS AND SYSTEMS FOR MANAGING SHIPMENT OF PRODUCTS FROM A DISTRIBUTION CENTER,” each of which is hereby incorporated by reference in its entirety.

### TECHNICAL FIELD

The present application relates to systems and methods for controlling shipment of products from a distribution center to a plurality of delivery points, and more particularly, doing so to determine an optimal route for one or more carriers.

### BACKGROUND

Merchants are typically required to ship products to consumers and/or retail stores. To do so, many merchants utilize one or more carriers to ship the products. The merchants may provide routes for the carries to deliver the products to their destinations. Multiple vehicles may make multiple stops at multiple destinations to deliver the products. These vehicles may be able to accommodate different weights and volumes of items. However, many merchants lack the infrastructure to adequately assign routes to the vehicles. As such, merchants are unable to adequately determine optimal routes for vehicles based on the products destinations. This results in increased delivery times, longer distances traveled by the vehicles, increased fuel consumption costs and vehicle wear. In addition, there are delivery time windows that should be met. Current technology is unable to account for these factors in controlling the transport and delivery of products. Embodiments of the present invention solve these problems.

### SUMMARY

In an embodiment of the invention, a method for managing shipment of a plurality of online orders between a pluralities of carriers from a distribution center is provided. The method can comprising: receiving four online orders, wherein each online order comprises a product and a delivery destination for delivering the product; determining the delivery destinations for delivering the product for each of the online orders; determining a distribution center to fulfill the online orders; selecting a first route for a first carrier to deliver a first product to a first delivery destination and a second product to a second delivery destination; and selecting a second route for a second carrier to deliver a third product to a third delivery destination and a fourth product to a fourth delivery destination. The first route and the second route can each be in a general curved shape starting from the distribution center, through the delivery destinations, and ending at the distribution center.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The features and advantages of the invention will be apparent from the following drawings wherein like reference numbers generally indicate identical, functionally similar, and/or structurally similar elements. In the drawings:

FIG. 1 illustrates an exemplary system for managing shipment of a plurality of online orders from a distribution center in accordance with embodiments of the present invention;

FIGS. 2A-F illustrate exemplary delivery routes for a single carrier from a distribution center in accordance with embodiments of the present invention;

FIG. 3 illustrates exemplary delivery routes for multiple carriers from a distribution center in accordance with embodiments of the present invention;

FIGS. 4 and 5 illustrates exemplary methods for managing shipment of a plurality of online orders in accordance with embodiments of the present invention;

FIG. 6 illustrates illustrate exemplary methods for managing shipment of a plurality of online orders in accordance with embodiments of the present invention;

FIGS. 7A and 7B exemplary methods for managing shipment of a plurality of online orders in accordance with embodiments of the present invention;

FIG. 8 illustrates another exemplary system for managing shipment of a plurality of online orders in accordance with embodiments of the present invention; and

FIG. 9 illustrates an exemplary computing device in accordance with embodiments of the present invention.

### DETAILED DESCRIPTION

Reference will now be made in detail to various embodiments of the present invention, examples of which are illustrated in the accompanying drawings. It is also important to note that any reference in the specification to “one embodiment, “an embodiment” or “an alternative embodiment” means that a particular feature, structure or characteristic described in connection with the embodiment is included in at least one embodiment of the invention. As such, the recitation of “in one embodiment's and the like throughout the specification do not necessarily refer to the same embodiment,

The systems and methods disclosed herein are intended to control shipment of a plurality of online orders for one or more carriers from a supply point, such as distribution center. In doing so, the systems and methods utilized are intended to determine an optimal route for each carrier to deliver a plurality of products to a plurality of delivery destinations. The delivery destinations may in one example be one or both of a retail store and a consumer. As such, the systems and methods disclosed herein are intended to be utilized in a retail setting and for one or more consumers and/or retail stores. However, the systems and methods disclosed herein can be utilized in any setting in which one or more items are to be delivered to different destinations.

The term “carrier,” as used herein, can refer to any type of vehicle to deliver one or more products. As such, exemplary carriers include, but are not limited to, a truck, a car, a plane, a ship, a drone, etc.

The term “consumer,” as used herein, can refer to any purchaser or potentially purchaser of a product who intends to use the product for personal use.

The term “distribution center,” as used herein, can refer to any storage facility having an array of products and in charge of processing one or more online orders. The distribution center can ship one or more products directly to retail stores and/or consumers.

The term “retail store,” as used herein, can refer to any retailer or merchant selling products in small quantities directly to the consumer. As such, the retail store can be a brick and mortar store.

One way in which systems configured as disclosed herein can improve upon the centralized approach is combining the data from the respective local computing devices prior to communicating the information from the local computing devices to the central computing system. For example, a carrier traveling from a distribution center/retail location to a delivery location may be required to generate information about (1) the route being travelled, (2) space available in the truck for additional goods, (3) conditions within the truck, etc. Rather than transmitting each individual piece of data each time new data is generated, the central server, such as those located on a carrier, can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. In such a configuration, the central server, such as those located on a carrier, can be in communication with the retail location and/or distribution center, and can make changes to the route, destination, pickups/deliveries, etc., based on data received and processed while in-route between locations. Such a configuration may provide power and/or require more bandwidth than a centralized approach, but can result in a more dynamic system because of the ability to modify assignments and requirements immediately upon making an appropriate determination. In addition, such a system can be more secure, because there are multiple points of failure (rather than a single point of failure in a centralized system).

Yet another way in which system as disclosed herein can improve upon the centralized approach is by implementing a “hybrid” system, which may be more suitable for some specific configurations. In this system, a part of the network/system would be using the centralized approach (which can take advantage of the bandwidth savings described above), while the rest of the system is utilizing a decentralized approach (which can take advantage of the flexibility/increased security described above). For instance, the carriers can be connected to a central server at the distribution center, while the central server is connected to a decentralized network of computers.

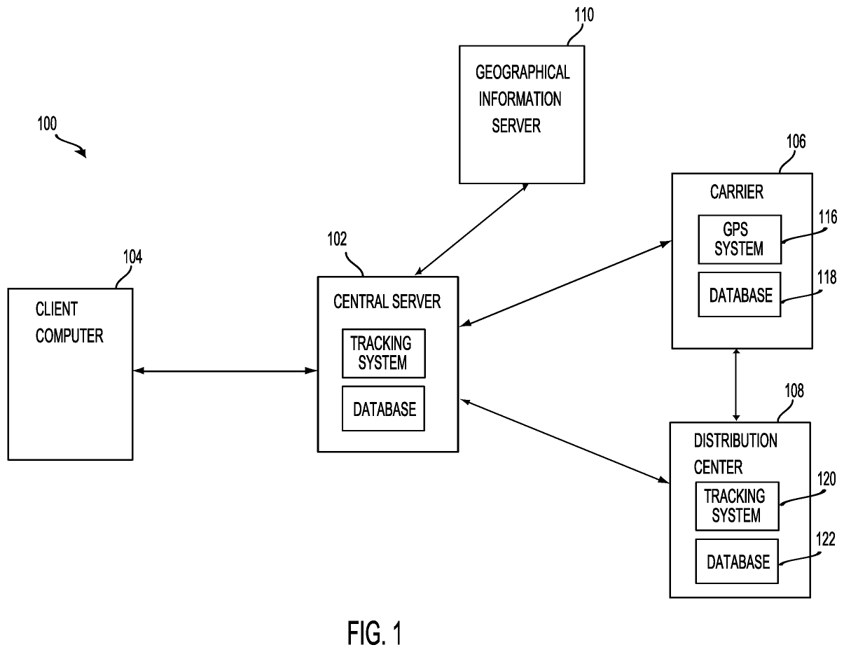

Referring now to FIG. 1, an exemplary system for controlling shipment of a plurality of items of products. The system 100 can include a central server 102, one or more client computers 104, one or more carriers 106, one or more distribution centers 108, and a geographical information server 110. The central server 102 comprises hardware and software for determining an optimal route for one or more carriers 106 from a distribution center 108, as will be discussed in more detail below. According to one embodiment, the central server 102 can be located on board in the carrier 106. For example, if the number of products being fulfilled and delivered from a particular distribution center 108 does not exceed an amount of products that a single, particular carrier 106 can carry, and/or if one or more delivery destinations have a designated carrier 106, then the central server 102 can be located at the carrier 106. In such a setup, the central server 102 can assign one or more routes, including the products, delivery destinations, and order for delivery to one or more carriers 106. According to another embodiment, the central server 102 can be located at the distribution center 108. As such, the distribution centers 108 can each have a central server 102. For example, if the number of products being fulfilled and delivered from a particular distribution center 108 exceeds an amount of products that a single, particular carrier 106 can carry, and the delivery destinations do not have dedicated carriers 106, the central server 102 can be located at the distribution center 108. In such a setup, the central server 102 can assign one or more routes, including the products, delivery destinations, and order for delivery to one or more carriers 106. According to yet another embodiment, the central server 102 can be separate from or combined with the carrier 106 and/or the distribution center 108. As such, the central server 102, in being separate from the carrier 106 and distribution center 108, can be located at a remote location by itself.

The central server 102 can be in communication with the client computer 104 to receive one or more online orders. The client computer 104 can be any computing device that permits a user to place an online order. The online order may also be automatically generated by the client computer 104 or the central server 102, without the need for the client computer 104. According to an embodiment, the client computer 104 can be located at a place of business of a seller selling one or more products (i.e., a retail store). As such, the client computer 104 can be in the form of a kiosk, an electronic cash register, inventory system or any other computing device. According to another embodiment, the client computer 104 can belong to a consumer purchasing one or more products. As such, the client computer 104 can be in the form a home computer, a laptop, a cell phone, a smart phone, or any other computer.

The order may include one or more of a product and a delivery destination for the product. According to an embodiment, the online order can comprise a plurality of products to be delivered to a single destination. According to another embodiment, the online order can comprise a plurality of products to be delivered to multiple, different destinations. Moreover, the product can be perishable, and/or can contain an expiration data. As such, exemplary products include, but are not limited to, electronics, movies, clothing, sporting equipment, furniture, food, etc. Further, the method of delivery can comprise one or more levels for shipping a product based upon a time the product can be delivered. As such, the time can be a range of days or an expected date of delivery of the product. According to an embodiment, the method of delivery can comprise “Basic Shipping” (3-6 business days), “Premium Shipping” (2-3 business days), and “Express Shipping” (1-2 business days).

The central server 102 can identify contents of the online order. As such, the central server 102 can identify a product, an identification number of the product (i.e., SKU number), and a delivery destination of the product. Along these lines, the central server 102 can determine one or more of an estimated unloading time for unloading products at a delivery destination and a delivery window for delivering products to the delivery destination. The unloading time can be a time window, such as a first time that the delivery destination is open to receive deliveries and a second time that the delivery destination no longer receives deliveries. As such, according to an embodiment, the delivery window for a consumer may be between the hours of 8:00 A.M. and 7:00 P.M. According to another embodiment, the delivery window for a retail store may between the hours of 8:00 P.M. and 7:00 A.M.

Moreover, the central server 102 can also be in communication with one or more distribution centers 108 to fulfill the online order. The distribution centers 108 may be assigned to supply items to a plurality of retail stores in their respective region. The retail stores may be grouped into a region based on their geographical location or other factors. The distribution center 108 can comprise a tracking system 120 to track one or more products in the distribution center 108 and a database 122 to manage an inventory of products in the distribution center 108. The databases may be combined into one or more databases or be part of the central server 102. As such, the central server 102 can locate a distribution center 108 capable of fulfilling the online order. The distribution center 108 may have all or less than all of the products in an online order. As such, the delivery may only partially fulfill the online order. Moreover, the distribution center 108 may be within a predetermined distance from the delivery destinations. The predetermined distance can be 5 miles, 10 miles, 20 miles, or 100 miles, etc. According to an embodiment, the central server 102 can identify a distribution center 108 within 20 miles of each of the delivery destinations.

The central server 102 can further be in communication with the geographical information server 110 to request and receive geographical information of a geographical region. The geographical information server 110 may be a third party server or may be part of the central server 102. The geographical information can comprise one or more of location information for the distribution centers 108 and the delivery points, such as coordinates, latitude/longitude, and other location information, road information and traffic information. Moreover, the geographical information server 110 can provide the road information and traffic information for specific periods of times, such as months, days, hours, etc. As such, the geographical information server 110 can provide the central server 102 with anticipated traffic for select months, days, times, etc.

Along these lines, the geographical information server 110 can also provide the central server 102 with road closures, roads having weight limits, road conditions, large vehicle limitations, etc. Also, the geographical region can be a predetermined distance in the vicinity of the furthest delivery destination from the distribution center 108. The predetermined distance may be, for example, 1 mile, 2 miles, 5 miles, 10 miles, etc.

To receive geographical information, the central server 102 can be in communication with the geographical information server 102 in real-time and receive data as needed. Alternatively, the central server 102 can periodically connect to the geographical information server 102 and get batches of geographical information data (via updates or downloading). This would require more storage, but would improve processing time of the central server since it would no longer need a live connection.

In an exemplary embodiment of the invention, a distribution center 108 may supply a store or group of retail stores (not illustrated) in the surrounding area. The retail stores served by the distribution center 108 may be grouped together as noted above or in some other manner. The distribution center 108 may receive the online orders for the retail stores that it serves. The online orders may come directly from the retail stores inventory systems or via the central server 102. The central server 102 may examine the geography of the delivery and shipping points and generate a delivery route. The delivery route may form a curved line representing a delivery route that originates and ends at or near the distribution center 108 and that hits all of the delivery points. At or near the distribution center 108 may be within 0.5, 1, 5 or 10 miles of the distribution center 108.

By being in communication with the geographical information server 110, the central server 102 can also determine a distance between each of the delivery destinations and/or a distance from the distribution center 108 to each of the delivery destinations. In doing so, the central server 102 can determine a total distance from the distribution center 108, through a subset or all of delivery destinations, and returning to the distribution center 108. Along these lines, the central server 102 can further determine an amount of right turns and left turns in traveling from the distribution center 108, through a subset or all of delivery destinations, and returning to the distribution center 108.

As such, the central server 102 can determine one or more routes for one or more carriers 106 to deliver to a subset of a plurality of delivery destinations from the distribution center 108 and to select an optimal route. The optimal route can be in a general curved shape starting from the distribution center 108, through the subset of delivery destinations, and ending at the distribution center 108. The subset of delivery destinations may be less than the total amount of delivery destinations. According to an embodiment, the route can loop in a clockwise fashion starting from the distribution center, through the subset of delivery destinations, and may end at or near the distribution center 108. According to an embodiment, the route can loop in a counter clockwise fashion starting from the distribution center, through the subset of delivery destinations, and may end at or near the distribution center 108.

To determine the optimal route, the central server 102 can determine a plurality of optional routes for one or more carriers 106 to deliver to subsets of a plurality of delivery destinations from the distribution center 108. As stated above, the subset of delivery destinations may be less than the total amount of delivery destinations. As such, the central server 102 can determine optional routes for each possible combination of subsets of the delivery destinations for the carrier 106. Along these lines, each of the optional routes can loop in a clockwise or counter-clockwise fashion starting from the distribution center 108, through each subset of the delivery destinations, and ending at the distribution center 108. According to an embodiment, the optional routes for the carrier 106 can loop in a clockwise fashion starting from the distribution center 108, through the subset of delivery destinations, and end at the distribution center 108. According to another embodiment, the optional routes for the carrier can loop in a counter-clock wise fashion starting from the distribution center 108, through the subset of delivery destinations, and ending at the distribution center 108.

Along these lines, the central server 102 can determine the optional routes for the carrier 106 based on geographical information received from the geographical information server 110. As such, the central server 102 can determine the optional routes for the carrier 106 based on road information and/or traffic information. Consequently, for example, the central server can determine the optional routes for the carrier 106 based on one or more of road closures, left turns, road conditions, and large vehicle limitations. This can allow the central server 102 to determine one or more roads for the carrier 106 to possibly travel in the optional routes

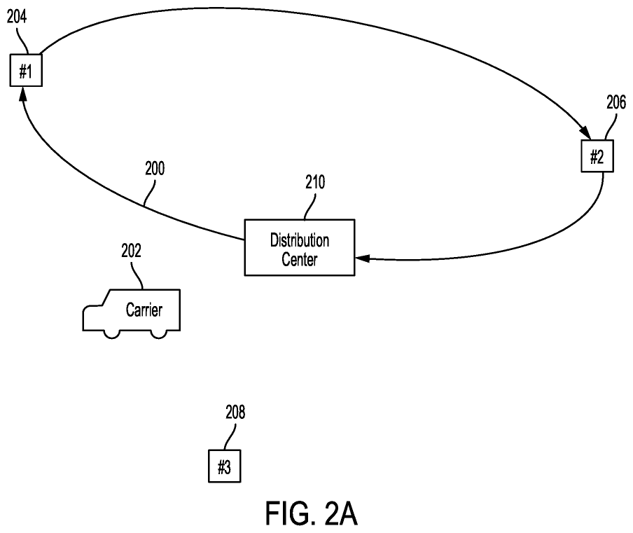

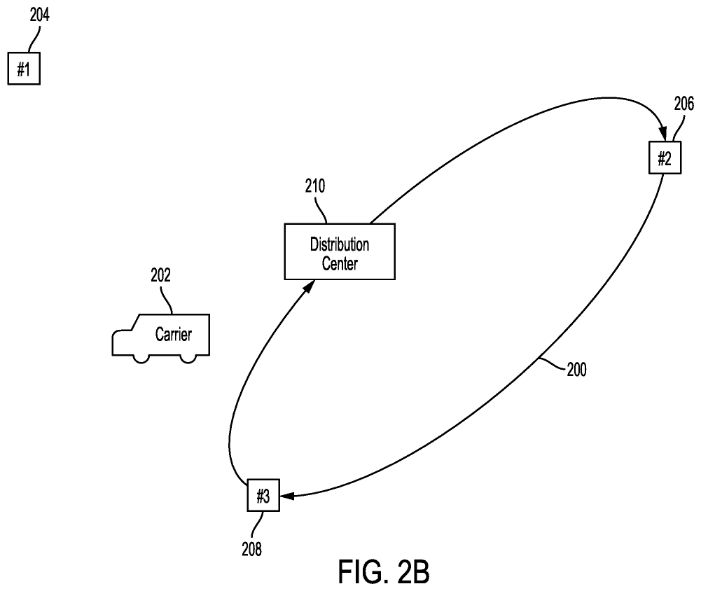

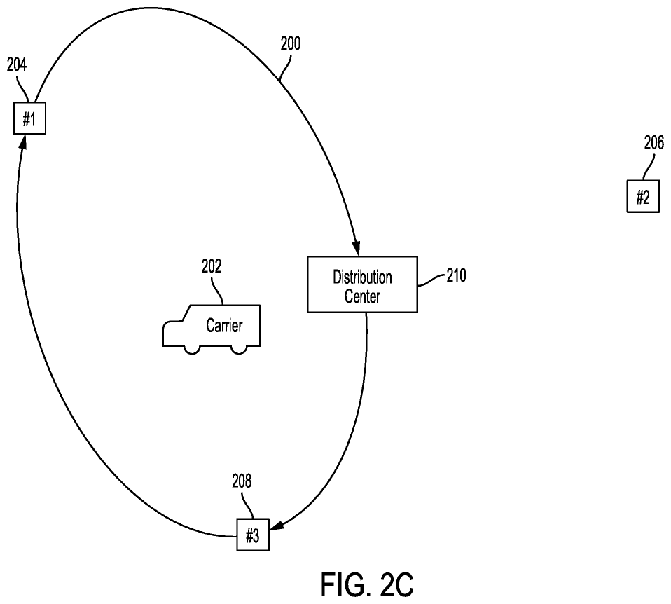

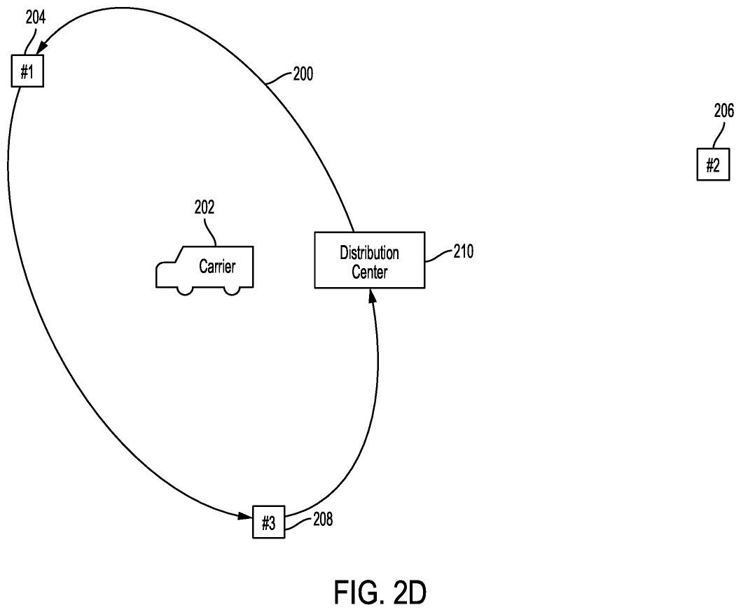

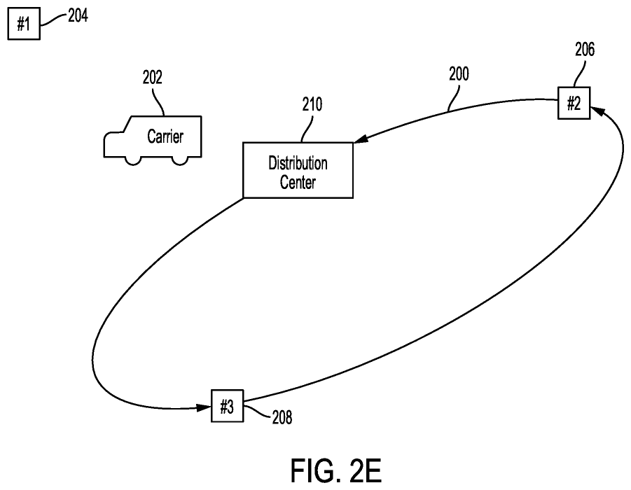

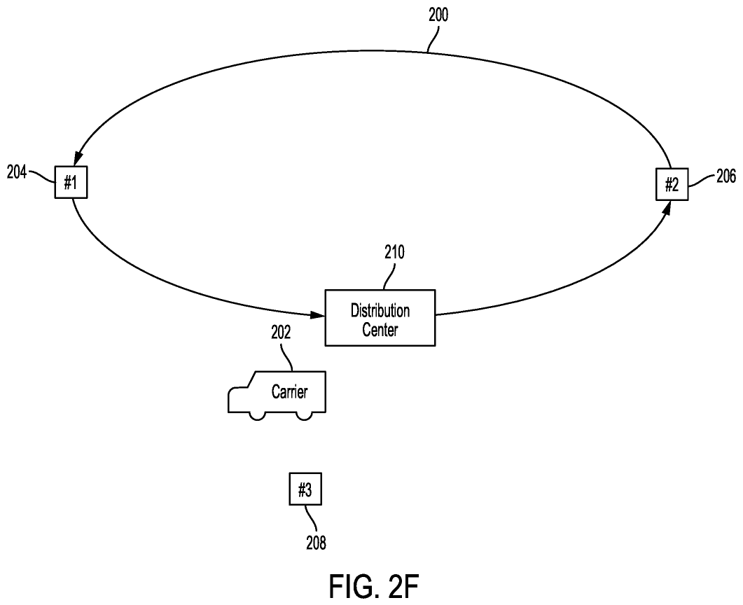

Referring now to FIGS. 2A-F, exemplary optional routes 200 for a single carrier 202 to deliver to two of three delivery destinations 204, 206, and 208 from a distribution center 210 central to the delivery destination 204, 206, and 206 in a general curved shape are depicted. FIGS. 2A-C depict the carrier 202 looping in a clockwise fashion starting from the distribution center 210, through two of the three delivery destinations 204, 206, and 208, and ending at the distribution center 210. Specifically, FIG. 2A depicts an optional route 200 for the carrier 202 to deliver initially to a first delivery destination 204 and, thereafter, to a second delivery destination 206. FIG. 2B depicts an optional route for 200 for the carrier to delivery initially to the second delivery destination 206 and, thereafter, to a third delivery destination 208. FIG. 2C depicts an optional route 200 for the carrier 202 to deliver initially to the third delivery destination 208 and, thereafter, to the first delivery destination 204.

Moreover, FIGS. 2D-F depict the carrier 202 looping in a counter-clockwise fashion starting from the distribution center 210, through two of the three delivery destinations 204, 206, and 208, and ending at the distribution center 210. Specifically, FIG. 2D depicts an optional route 200 for the carrier 202 to delivery initially to the first delivery destination 204 and, thereafter, to the third delivery destination 208. FIG. 2E depicts an optional route 200 for the carrier 202 to deliver initially to the third delivery destination 208 and, thereafter, to the second delivery destination 206. FIG. 2F depicts an optional route 200 for the carrier 202 to deliver initially to the second delivery destination 206 and, thereafter, to the first delivery destination 204.

Referring back to FIG. 1, the central server 102 can determine a score for each of the optional routes for one or more carriers 106 through a subset of the delivery destinations. The higher the score can represent a more optimal route for a carrier 106. As such, the score can depend on a number of factors. For instance, the score can be based one or more of a distance between each of the delivery destinations in the optional route, a distance from a subset of the delivery destinations (e.g., two of the three delivery destinations) to the distribution center in the optional route, and a total distance traveled in the optional route (i.e., starting from the distribution center, traveling to each of the subset of delivery destinations, and returning to the distribution center). Moreover, the score can be also based one or more of a departure time of the carrier 106 in leaving from the distribution center 108, an arrival time of the carrier 106 returning to the distribution center 108 after delivery of the products to the delivery destinations, an estimated unloading time for unloading one or more products from the carrier 106 at each of the delivery destinations in the optional route, and a delivery window for delivering one or more products to each of the delivery destinations in the optional route.

Additionally, the score can be further based on geographical information in the optional route. As stated above, geographical information can include road information and/or traffic information provided for specific periods of times, such as months, days, hours, etc. As such, the score can be based on one or more of an anticipated traffic time to one or more of the delivery destinations in the optional route, fuel costs, road conditions to one or more delivery destinations in the optional route, and left turns in one or more of the delivery destinations in the optional route.

Moreover, one or more of the factors for determining the score of an optimal route can be weighted or unweighted. Along these lines, the number and/or weight of the factors for determining the score of an optimal route can be customized. As such, the number and/or weight of the factors can be selected based on one or more objectives in designing the optimal route. The objectives can be a departure time from the distribution center, a return time to the distribution center, a delivery time to one or more of the delivery destinations, a loading time to load the truck at the distribution center prior to starting the route, an unloading time of one or more of the delivery destinations, a traffic time for driving one or more roads, a total delivery time, a least number of lights during the route between the stop(s), etc. Moreover, the objectives can be unique to the distribution center. For instance, the objectives can be managing carrier loading and departure time from the distribution center. Thus, the factors relating to a departure time from the distribution center and a loading time to load the truck at the distribution center prior to starting the route can be weighted.

As such, the central server 102 can select an optimal route for the carrier 106 based on the score of each of the optional routes. According to an embodiment, the optimal route for the carrier 106 can be the optional route with the highest score. The optimal route may balance the needs for reduced fuel consumption, delivery time, distance traveled and the like.

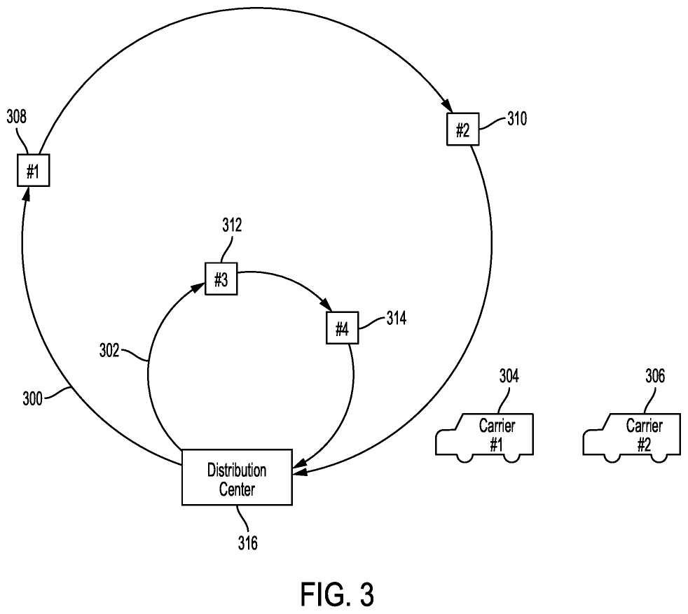

Referring now to FIG. 3, exemplary optimal routes 300, 302 for two carriers 304, 306 to deliver to two of four delivery destinations 308, 310, 312, 314 from a distribution center 316 are depicted. Specifically, FIG. 3 illustrates a first carrier 304 looping in a clockwise fashion starting from the distribution center 316, through a first delivery destination 308 and a second delivery destination 310, and ending at the distribution center 316. FIG. 3 also illustrates a second carrier 306 looping in a clockwise fashion from the distribution center 316, through a third delivery destination 312 and a fourth delivery destination 314, and ending at the distribution center 316.

In arriving at the optimal routes 300, 302 for the two carriers 304, 306, embodiments of the present invention as discussed above can be utilized. As such, the central server 102 (identified in FIG. 1) can determine a plurality of optional routes to deliver to each possible combination of subsets of the delivery destinations 308, 310, 312, 314 from the distribution center 216. As discussed above, each of the optional routes can loop in a clockwise or counter clockwise fashion starting from the distribution center 316, through each subset of the delivery destinations, and ending at the distribution center 316. Moreover, the central server 102 (identified in FIG. 1) can determine a score for each of the optional routes based on one or more of a number of factors as discussed above. The first optimal route 300 and the second optimal route 302 can be based on the score. According to an embodiment, the first optimal route 300 and the second optimal route 302 can be the routes with the highest scores from the optional routes. As such, the first carrier 304 can be assigned one of the first delivery route 300, and the second delivery route 302, and the second carrier 306 can be assigned the other one of the first delivery route 300 and the second delivery route 302. For example, as illustrated, the first carrier 304 can be assigned the first optimal route 300 the second carrier 306 can be assigned the second optimal route 302.

Referring back to FIG. 1, as stated above, the central server 102 can be in communication with the distribution center 108. The distribution center 108 can be in communication with one or more carriers 106. The carrier 106 can comprise a global positioning system 116 to guide an operator of the carrier to one or more delivery destinations and a database 118 to store one or more optimal routes. According to an embodiment, the central server 102 can send the optimal route for the carrier 106 to the distribution center 108. The distribution center 108 provide the optimal route to an operator of the carrier 106 in form of a printout. According to another embodiment, the central server 102 can send the optimal route for the carrier 106 to the distribution center 108 and, thereafter, the distribution center 108 can send the optimal route to the carrier 106. The carrier 106 can store the optimal route in the database 118.

The central server 102 can also be in communication with one or more carriers 106 to send to optimal routes directly thereto. As stated above, the carrier 106 can store the optimal route in the database 118. Along these lines, the central server 102 can track one or more carriers 106 during delivery to one or more delivery destinations. As such, the central server 102 can alter the optimal route for the carrier 106 based on a number of factors as discussed above. For example, the central server 102 can alter the optimal route for the carrier 106 based on geographical information, such as road information and/or traffic information.

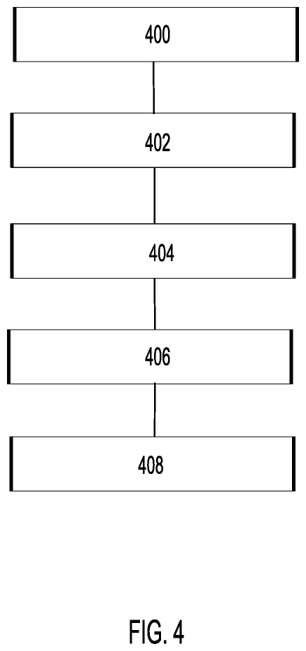

Referring now to FIG. 4, a method for managing shipment of a plurality of online orders for a plurality of carriers from a distribution center is provided. First, at step 400, four online orders are received. The online orders each comprises a product and a delivery destination for delivering the product. Thereafter, at step 402, the delivery destinations for delivering the product for each of the online orders is determined. Next, at step 404, a distribution center to fulfill the online orders is determined. Subsequently, at step 406, a first route for a first carrier to deliver a first product to a first delivery destination and a second product to a second delivery destination is determined. Also, at step 408, a second route for a second carrier to deliver a third product to a third delivery destination and a fourth product to a fourth delivery destination is determined. The first route and the second route are each in a general curved shape starting from the distribution center, through the delivery destinations, and ending at the distribution center. As such, each of these steps can be processed in accordance with embodiments of the invention as discussed above.

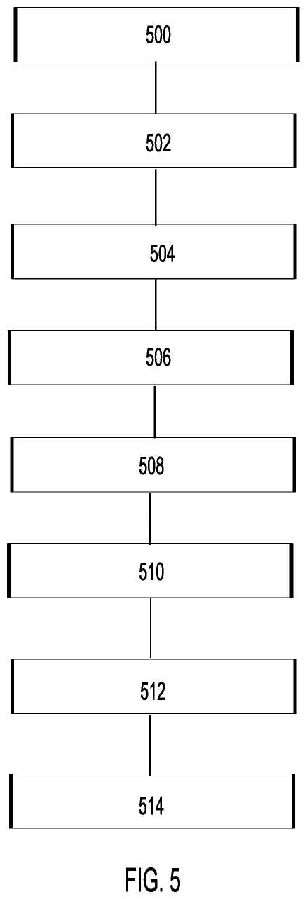

Referring now to FIG. 5, a method for managing shipment of a plurality of online orders for a single carrier from a distribution center is provided. First, at step 500, three online orders are received. The online orders each comprises a product and a delivery destination for delivery the product. Thereafter, at step 502, the delivery destinations for delivering the product for each of the online orders is determined. Next, at step 504, a distribution center to fulfill the online orders is determined. Subsequently, at step 506, a first route for a carrier to deliver a first product of a first online order to a first delivery destination and a second product of a second online order to a second delivery destination is determined and, at step 508, a score for the first route is determined. Following, at step 510, a second route for the carrier to deliver a first product of a first online order to a first delivery destination and a third product of a third online order to a third delivery destination is determined and, at step 512, a score for the second route is determined. Successively, at step 514, the first route or the second route is selected for the carrier based on the score. The first route and the second route are each in a general curved shape starting from the distribution center, through the delivery destinations, and ending at the distribution center. As such, each of these steps can be processed in accordance with embodiments of the invention as discussed above.

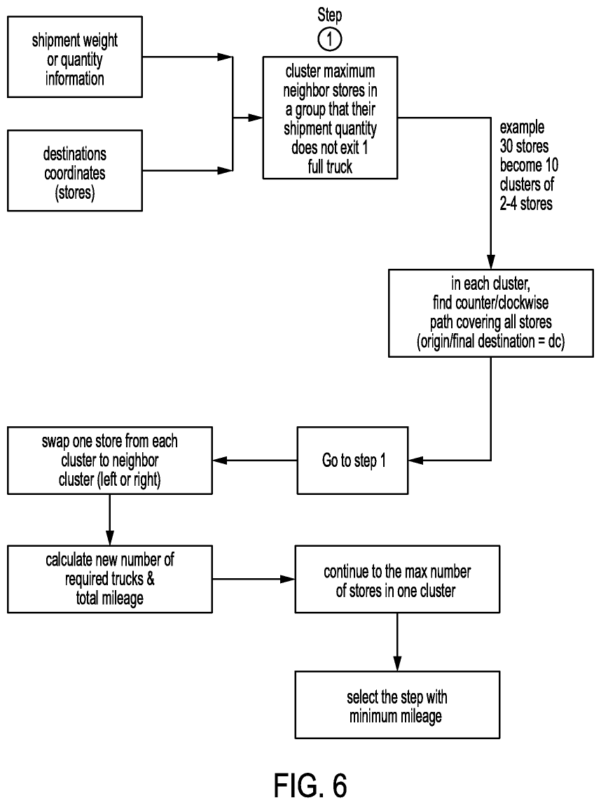

FIG. 6 illustrates a method according to an embodiment of the invention. The central server obtains online order information for deliveries from a distribution center to the retail stores that the distribution center serves. From the order information, the items ordered are identified. The central server may the retrieve from a database or otherwise determine the item characteristics, such as item package size, weight, quantity, etc. The delivery points are also determined, for example, from the online order. This may include determining the coordinates for the retail stores, such as GPS coordinates and the like. The central server may also obtain the specifications of the delivery vehicle used by the distribution center 108, such as weight limits, volume, capacity, range, etc. from a database.

Using the vehicle and online order information, the central server groups the retail stores into clusters such that the shipment to the cluster of stores does not exceed one full delivery vehicle. This initial grouping may be made based on geography as discussed above, with retail stores located nearest each other initially in the same group. Other processes for clustering the retail stores may include a random grouping or a first best estimate based on the item and delivery information. For example, an organization may have thirty stores in a region that are supplied by a distribution center. These thirty stores may clustered into ten clusters of 2-4 stores.

In each cluster, a curved delivery route covering all of the stores in the cluster is determined. The origin and final destination of the route may be the distribution center. The curved delivery route may be counter clockwise. The route may be determined as described above or using know best fit line methods.

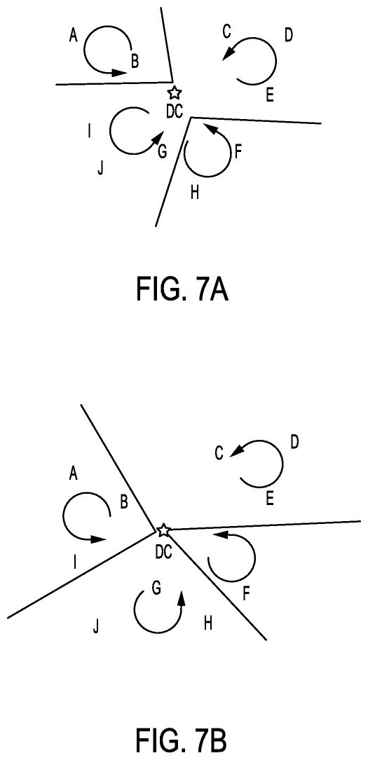

For illustrative purposes, FIG. 7A sows a simple example of a distribution center and geo-clustering of stores. A distribution center DC is shown among a group of retail stores A-J. The stores are grouped into four clusters 1-4. Cluster 1 includes stores A and B, cluster 2 includes stores C, D, and E, cluster 3 includes stores F and H, cluster 4 includes stores I, J and G. Counter clockwise delivery routes are show for each cluster. The scores associated with the routes and the number of vehicles utilized are determined.

Returning to FIG. 6, stores from a cluster may be moved or swapped with another cluster. In one example, a store from each cluster may be moved to an adjacent cluster. The move or swap may be done by moving the store either to the left or to the right. FIG. 7B shows an example after the reconfiguring the cluster of FIG. 7A. In this example, store I was moved from cluster 4 to the cluster 1 and store H was moved from cluster 3 to cluster 4. In some cases, the move or swap may not be able to be performed due to vehicle capacity issues. Here, cluster 1 is not able to exchange stores with other clusters as doing so would exceed to capacity of one vehicle assigned to each cluster.

A counter clockwise route is calculated for each new cluster. This may include determining the scores associated with each new route. For example, a new number of vehicles required to make the deliveries and the total distance traveled may be determined. The score results are determined and saved. The process is repeated to achieve the maximum number of stores in one cluster. In such a case, the maximum number of stores may be serviced by one truck. The scores associated with each clustering of stores is evaluated, and the clustering with the lowest total scores is selected. The selection may also be made on other factors, such as minimum mileage, minimum number of trucks, etc.

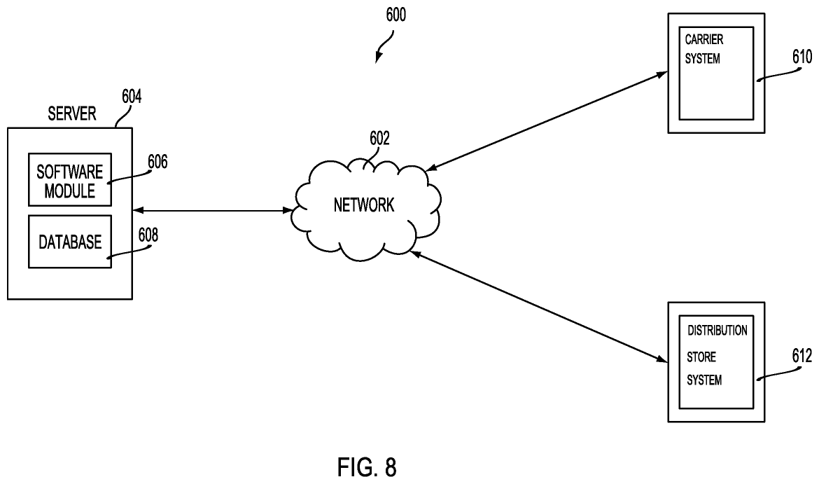

Referring now to FIG. 8, a diagram of an exemplary system 600 is shown that may be utilized in accordance with one or more embodiments of the present invention as discussed above. System 600 can include a network 602, server 604, software module 606, database 608, one or more carrier systems 610, and one or distribution store systems 612.

Network 602 can provide network access, data transport and other services to the devices coupled to it in online order to send/receive data from any number of user devices, as explained above. In general, network 602 can include and implement any commonly defined network architectures including those defined by standard bodies, such as the Global System for Mobile Communication (GSM) Association, the Internet Engineering Task Force (IETF), and the Worldwide Interoperability for Microwave Access (WiMAX) forum.

Server 604 can also be any type of communication device coupled to network 602, including but not limited to, a personal computer, a server computer, a series of server computers, a mini computer, and a mainframe computer, or combinations thereof. Server 604 can be a web server (or a series of servers) running a network operating system. Server 604 can be used for and/or provide cloud and/or network central.

Software module 606 can be a module that is configured to send, process, and receive information at server 604. Software module 606 can provide another mechanism for sending and receiving data at server 604 besides handling requests through web server functionalities.

Although software module 606 can be described in relation to server 604, software module 606 can reside on any other device. Further, the functionality of software module 606 can be duplicated on, distributed across, and/or performed by one or more other devices, either in whole or in part.

Database 608 can be any type of database, including a database managed by a database management system (DBMS). A DBMS is typically implemented as an engine that controls organization, storage, management, and retrieval of data in a database. DBMS s frequently provide the ability to query, backup and replicate, enforce rules, provide security, do computation, perform change and access logging, and automate optimization.

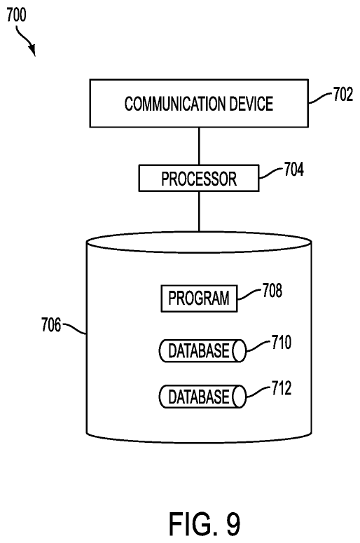

Referring now to FIG. 9, a schematic diagram of an exemplary central server 700 is illustrated in accordance with one or more embodiments of the present invention as discussed above. The exemplary central server 700 includes a processor 704, a communication device 702 and a data storage or memory component 706. The processor 704 is in communication with both the communication device 702 and the memory component 706. The communication device 702 may be configured to communicate information via a communication channel, wired or wireless, to electronically transmit and receive digital data related to the functions discussed herein. The communication device 702 may also be used to communicate, for example, with one or more human readable display devices. The memory component 706 may comprise any appropriate information memory component, including combinations of magnetic memory components (e.g., magnetic tape, radio frequency tags, and hard disk drives), optical memory components, computer readable media, and/or semiconductor memory devices. The memory component 706 may store the program 708 for controlling the processor 704. The processor 704 performs instructions of the program 708, and thereby operates in accordance with the present invention. The memory component 706 may also store and send all or some of the information sent to the processor 704 in one or more databases 710 and 712.

Communication device 702 may include an input device including any mechanism or combination of mechanisms that permit an operator to input information to communication device 702. Communication device 702 may also include an output device that can include any mechanism or combination of mechanisms that outputs information to the operator.

While various exemplary embodiments have been described above, it should be understood that they have been presented by way of example only, and not limitation. Thus, the breadth and scope of the present disclosure should not be limited by any of the above-described exemplary embodiments.

Although the foregoing description is directed to the preferred embodiments of the invention, it is noted that other variations and modifications will be apparent to those skilled in the art, and can be made without departing from the spirit or scope of the invention. Moreover, features described in connection with one embodiment of the invention can be used in conjunction with other embodiments, even if not explicitly stated above.

What is claimed is:

1. A method performed by a central server for managing shipment of online orders, the method comprising:
receiving a plurality of online orders for delivering products to different delivery destinations;
determining a distribution center and at least one carrier to fulfill the plurality of online orders;
determining a plurality of candidate routes to deliver products to each possible subset of the different delivery destinations, wherein:
each of the plurality of candidate routes is a clockwise or counter-clockwise loop route starting from the distribution center, through respective delivery destinations in a respective possible subset, and ending at the distribution center,
the plurality of candidate routes include at least one clockwise loop route and at least one counter-clockwise loop route;
determining a score for each of the plurality of candidate routes;
selecting, for each respective carrier of the at least one carrier, an optimal route from the plurality of candidate routes based on their respective scores; and
transmitting the optimal route to each respective carrier for shipment of the plurality of online orders according to the optimal route.

2. The method of claim 1, wherein:
the at least one carrier includes a first carrier and a second carrier;
the method further comprises:
assigning a first optimal route selected from the plurality of candidate routes to the first carrier,
assigning a second optimal route selected from the plurality of candidate routes to the second carrier;
the first optimal route and the second optimal route cover all of the different delivery destinations; and
the first optimal route and the second optimal route include two non-overlapping subsets of the different delivery destinations, respectively.

3. The method of claim 1, further comprising:
receiving traffic information from a third party source,
wherein the score for each of the plurality of candidate routes is determined based on the traffic information.

4. The method of claim 1, further comprising:
determining an estimated time of arrival for each delivery destination in the plurality of candidate routes,
wherein the score for each of the plurality of candidate routes is determined based on the estimated time of arrival.

5. The method of claim 1, further comprising:
determining an estimated time of unloading products at each delivery destination in the plurality of candidate routes,
wherein the score for each of the plurality of candidate routes is determined based on the estimated time of unloading products.

6. The method of claim 1, further comprising:
determining a completion time for completing each of plurality of candidate routes,
wherein the score for each of the plurality of candidate routes is determined based on the completion time.

7. The method of claim 1, further comprising:
determining a completion distance for completing each of plurality of candidate routes,
wherein the score for each of the plurality of candidate routes is determined based on the completion distance.

8. The method of claim 1, further comprising:
determining an amount of left turns for completing each of plurality of candidate routes,
wherein the score for each of the plurality of candidate routes is determined based on the amount of left turns.

9. The method of claim 1, wherein the plurality of online orders are received from at least one of a retail store or a customer.

10. The method of claim 1, further comprising:
tracking a location of each respective carrier during the shipment;
receiving, from a geographical information server, geographic information based on the location of each respective carrier at periodic intervals;
updating the optimal route based on the location of each respective carrier and the geographic information; and
transmitting the updated optimal route to each respective carrier for continuing the shipment according to the updated optimal route.

11. A system for managing shipment of online orders, the system comprising:
a non-transitory memory having instructions stored thereon; and
a processor configured to read the instructions to:
receive a plurality of online orders for delivering products to different delivery destinations,
determine a distribution center and at least one carrier to fulfill the plurality of online orders,
determine a plurality of candidate routes to deliver products to each possible subset of the different delivery destinations, wherein:
each of the plurality of candidate routes is a clockwise or counter-clockwise loop route starting from the distribution center, through respective delivery destinations in a respective possible subset, and ending at the distribution center,
the plurality of candidate routes include at least one clockwise loop route and at least one counter-clockwise loop route;
determine a score for each of the plurality of candidate routes,
select, for each respective carrier of the at least one carrier, an optimal route from the plurality of candidate routes based on their respective scores, and
transmit the optimal route to each respective carrier for shipment of the plurality of online orders according to the optimal route.

12. The system of claim 11, wherein:
the at least one carrier includes a first carrier and a second carrier;
the processor is further configured to read the instructions to:
assign a first optimal route selected from the plurality of candidate routes to the first carrier,
assign a second optimal route selected from the plurality of candidate routes to the second carrier;
the first optimal route and the second optimal route cover all of the different delivery destinations; and
the first optimal route and the second optimal route include two non-overlapping subsets of the different delivery destinations, respectively.

13. The system of claim 11, wherein the processor is further configured to read the instructions to:
receive traffic information from a third party source,
wherein the score for each of the plurality of candidate routes is determined based on the traffic information.

14. The system of claim 11, wherein the processor is further configured to read the instructions to:
determine an estimated time of arrival for each delivery destination in the plurality of candidate routes,
wherein the score for each of the plurality of candidate routes is determined based on the estimated time of arrival.

15. The system of claim 11, wherein the processor is further configured to read the instructions to:
determine an estimated time of unloading products at each delivery destination in the plurality of candidate routes,
wherein the score for each of the plurality of candidate routes is determined based on the estimated time of unloading products.

16. The system of claim 11, wherein the processor is further configured to read the instructions to:
determine a completion time for completing each of plurality of candidate routes,
wherein the score for each of the plurality of candidate routes is determined based on the completion time.

17. The system of claim 11, wherein the processor is further configured to read the instructions to:
determine a completion distance for completing each of plurality of candidate routes,
wherein the score for each of the plurality of candidate routes is determined based on the completion distance.

18. The system of claim 11, wherein the processor is further configured to read the instructions to:
determine an amount of left turns for completing each of plurality of candidate routes,
wherein the score for each of the plurality of candidate routes is determined based on the amount of left turns.

19. The system of claim 11, wherein the plurality of online orders are received from at least one of a retail store or a customer.

20. The system of claim 11, wherein the processor is further configured to read the instructions to:
track a location of each respective carrier during the shipment;
receive, from a geographical information server, geographic information based on the location of each respective carrier at periodic intervals;
update the optimal route based on the location of each respective carrier and the geographic information; and
transmit the updated optimal route to each respective carrier for continuing the shipment according to the updated optimal route.
